(19) United States
(12) Patent Application Publication
(10) Pub. No.: US 2026/0087324 A1
(43) Pub. Date: Mar. 26, 2026

(54) DYNAMIC DEPLOYMENT OF GENERATIVE ARTIFICIAL INTELLIGENCE (AI) MODEL UPDATES USING LOW-RANK ADAPTATION

(71) Applicant: Microsoft Technology Licensing, LLC, Redmond, WA (US)

(72) Inventors: Xiaowen WANG, Redmond, WA (US); Mingxuan ZHANG, Lafayette, IN (US); Corneliu Iulian LUPU, Sammamish, WA (US); Chittibabu PACHARU, Redmond, WA (US); Abhinav MISHRA, Redmond, WA (US); Cristian Gelu PETRUTA, Redmond, WA (US); Adrian COSMA, Redmond, WA (US); Navjot Singh RATTAN, Redmond, WA (US); Xiangcheng YU, Woodinville, WA (US)

(21) Appl. No.: 18/893,222

(22) Filed: Sep. 23, 2024

(51) Int. Cl. G06N 3/0475

(52) U.S. Cl. CPC G06N 3/0475

(57) ABSTRACT

This disclosure describes a framework for efficiently and flexibly deploying updates and upgrades to a generative artificial intelligence (AI) model on a client device. Specifically, this disclosure describes a low-rank distribution system that uses low-rank adaptation to deploy new generative AI model updates to a client device via small update packages. By doing so, the low-rank distribution system can use regular software updates to efficiently deploy lightweight model updates to a client device, enhancing and expanding the capabilities of a generative AI model running on the client device.

### BACKGROUND

In recent years, significant progress has been made in the field of artificial intelligence (AI) and artificial neural networks (ANNs), driven by advancements in both hardware and software. One notable example of this progress is the ability to store and implement large language models (LLMs) on client devices, made possible by hardware advances. However, enhancing the functionality of LLMs on client devices remains an ongoing process due to the large size of these models, which presents various challenges. For instance, expanding the functionality of LLMs and providing efficient model updates are among the issues associated with utilizing LLMs on client devices.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of a low-rank distribution system that utilizes low-rank adaptation to distribute generative artificial intelligence (AI) model updates and upgrades to a client device.

FIG. 2 illustrates an example computing environment in which the low-rank distribution system is implemented.

FIG. 3 illustrates an example sequence diagram of generating low-rank matrices at a cloud computing system to be provided to a client device for a target task.

FIG. 4 illustrates an example layout of a client device having a generative artificial intelligence (AI) model that includes low-rank adapters for various target tasks.

FIG. 5 illustrates an example diagram of implementing the generative artificial intelligence (AI) model on the client device to perform a target task using low-rank matrices and low-rank adaptation.

FIGS. 6A-6B each illustrate an example series of acts of a computer-implemented method for deploying generative artificial intelligence (AI) model updates to one or more client devices.

FIG. 7 illustrates example components included within a computer system used to implement the low-rank distribution system.

### DETAILED DESCRIPTION

This disclosure describes a framework for efficiently and flexibly deploying generative artificial intelligence (AI) model updates and upgrades to a client device with a generative AI model. Specifically, this disclosure describes a low-rank distribution system that utilizes low-rank adaptation to deploy new generative AI model updates to a client device via small update packages. By doing so, the low-rank distribution system can utilize regular software updates to efficiently deploy lightweight model updates to a client device, significantly enhancing and expanding the capabilities of a generative AI model running on the client device.

Implementations of the present disclosure provide benefits and solve problems in the art with systems, computer-readable media, and computer-implemented methods that deploy lightweight and efficient low-rank adaptation updates, which significantly enhance and expand the capabilities of a generative AI model running on the client device. In particular, the low-rank distribution system generates and/or obtains a set of low-rank matrices corresponding to a target task and provides the set of low-rank matrices to a client device with a generative AI model, which enables the client device to use the generative AI model to perform the target task.

To illustrate, in various implementations, the low-rank distribution system deploys generative AI model updates to client devices by generating low-rank matrices corresponding to a target task within a generative AI model, either at a server device or a cloud computing system. Additionally, the low-rank distribution system provides the low-rank matrices corresponding to the target task, which include a small set of parameters, to a client device with a base version of a generative AI model. With the low-rank matrices, the client device can combine a large set of base model parameters associated with the generative AI model with the small set of parameters corresponding to the target task to generate a set of target parameters and generate an output corresponding to the target task by implementing the generative AI model using the set of target parameters. Furthermore, the low-rank distribution system can provide the client device with updated low-rank matrices corresponding to the target task, where the client device replaces a stored version of the low-rank matrices with the updated low-rank matrices.

In one or more implementations, when implemented on a client device that maintains a generative AI model with a large set of base model parameters, the low-rank distribution system receives low-rank matrices corresponding to a target task where the low-rank matrices include a small set of parameters corresponding to the target task. Additionally, the low-rank distribution system combines the large set of base model parameters with the small set of parameters corresponding to the target task to generate a set of target parameters in response to receiving a user request at the client device to perform the target task. Furthermore, the low-rank distribution system generates an output corresponding to the target task by implementing the generative AI model using the set of target parameters and provides the output for the target task in response to the user request.

As described in this disclosure, the low-rank distribution system delivers several significant technical benefits in terms of improved efficiency, accuracy, and flexibility compared to current systems. Furthermore, the low-rank distribution system provides several practical applications that address problems related to improving the efficiency of client devices using generative AI models to perform user-requested tasks.

To illustrate, while client devices are starting to include hardware and software capabilities to store and implement generative AI models, current functionality is limited. For instance, a generative AI model is often large in size and includes a large set of learned weights and parameters. For example, current generative AI models stored on client devices have a parameter size of around 3 gigabytes (GB). Updating the generative AI model on the client device includes sending a new large set of parameters to the client device. In some implementations, current systems require a complete model replacement on a client device to provide an updated model. This can result in heavy bandwidth usage and storage requirements, which limits the capabilities and functionality of using the generative AI model on the client device. Additionally, due to their size, these updates require separate transmissions, which results in infrequent updates.

In contrast to current systems, the low-rank distribution system deploys and implements updates to a generative AI model on a client device using small low-rank adaptation packages. To illustrate, the low-rank distribution system maintains a base version of a generative AI model on a client device and each low-rank adaptation package provides an additional function or feature that enables the generative AI model to perform a target task. In particular, a low-rank adaptation package includes a set of low-rank matrices for a target task. When the parameters from the low-rank matrices are combined with the large set of parameters from the base model, the generative AI model can use the combined parameter set to accurately and efficiently perform the target task.

By using low-rank matrices, the low-rank distribution system achieves reduced bandwidth and storage costs. For example, the low-rank distribution system provides small update changes rather than full model replacements, which significantly reduces bandwidth usage and storage requirements. This is especially beneficial in environments where bandwidth is costly or limited. As another efficiency gain, the low-rank distribution system provides frequent and seamless updates without experiencing significant downtime or the need to download large files. By doing so, the low-rank distribution system ensures that generative AI models remain up-to-date and face minimal disruption.

Additionally, the low-rank distribution system provides a lower computational overhead. For example, the low-rank distribution system improves efficiency on the client device by using fewer computational resources when applying these smaller updates. Because the updates are small in size, they require fewer computational resources to implement. Additionally, low-rank adapters can be selectively applied individually, which keeps the model's computational costs lower than running a full comprehensive model.

Furthermore, the low-rank distribution system provides improved flexibility through enhanced scalability. For example, the approach provided by the low-rank distribution system is highly scalable and can be applied across a variety of devices, from powerful servers to resource-constrained edge devices. This ensures that all devices, regardless of their hardware, can benefit from the improvements provided by the low-rank distribution system. Additionally, smaller update packages can be delivered more reliably across diverse network conditions and geographies.

Moreover, the low-rank distribution system provides an improved user experience. For example, by using low-rank matrices that are small-sized, the low-rank distribution system can deploy model updates regularly and ensure that models are always operating at peak performance on the client device, providing better results. Additionally, the low-rank distribution system provides minimal disruption by enabling frequent and seamless updates without causing significant downtime or the need to download large files.

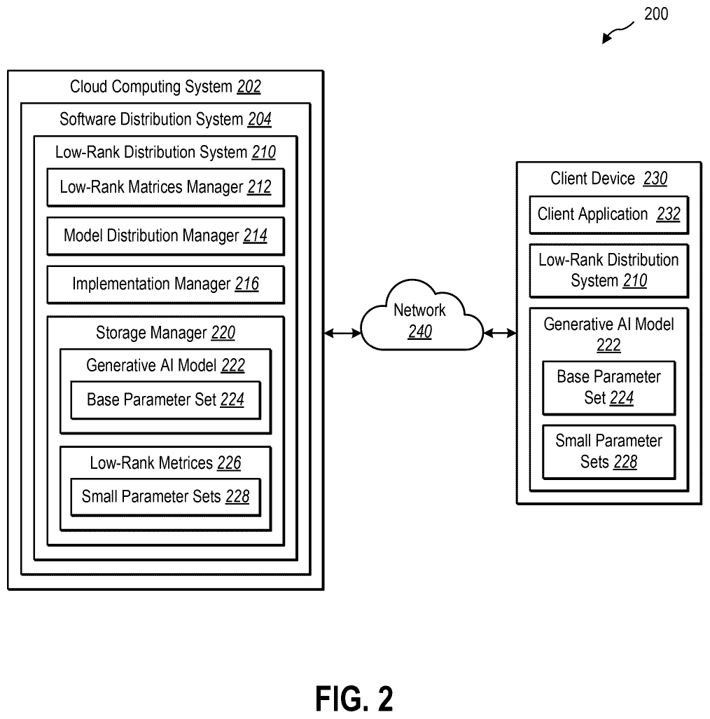

As illustrated in the preceding discussion, this disclosure uses a variety of terms to describe the features and advantages of one or more described implementations. For example, this disclosure describes search engine indexing in the context of a cloud computing system. As an example, the term “cloud computing system” refers to a network of interconnected computing devices that provide various services and applications to computing devices (e.g., server devices and client devices) inside or outside of the cloud computing system. An example of a cloud computing system is described below in connection with FIG. 2.

As an example, the term “generative artificial intelligence model” (or “generative AI model”) refers to a computational system that utilizes deep learning and a large number of parameters (e.g., billions or trillions for a large version and fewer for a small version) that are trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations.

Moreover, generative AI models are primarily based on transformer architectures for understanding, generating, and manipulating human language. Generative AI models can also utilize other types of architectures such as RNN architecture, long short-term memory (LSTM) model architecture, CNN architecture, or other types of architectures. Examples of generative AI models include generative pre-trained transformer (GPT) models like GPT-3.5, GPT-4, and GPT-4o, Phi-Silica, Phi-3, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a large action model (LAM), a small language model (SLM), and a small action model (SAM), which serve as text-based versions of a generative AI model, such as those that receive input prompts and generate output responses in the form of text, images, audio, and/or actions.

As another example, the terms “prompt,” “model prompt,” or “generative AI model prompt” refer to a request provided to a generative AI model to create generative AI model output based on plain language guidance prompts. Examples of prompts, which are further described below, include a session plan generation prompt, an action execution prompt, a database query prompt, and a visual context prompt.

As an example, the term “low-rank matrices” refers to small sets of parameters corresponding to a target task. Low-rank matrices can be combined with, supplement, or modify a large set of parameters corresponding to a generative AI model to enable the generative AI model to perform the target task. Low-rank matrices can be stored in non-volatile memory of a client device and selectively applied by the client device with the generative AI model to perform the target task.

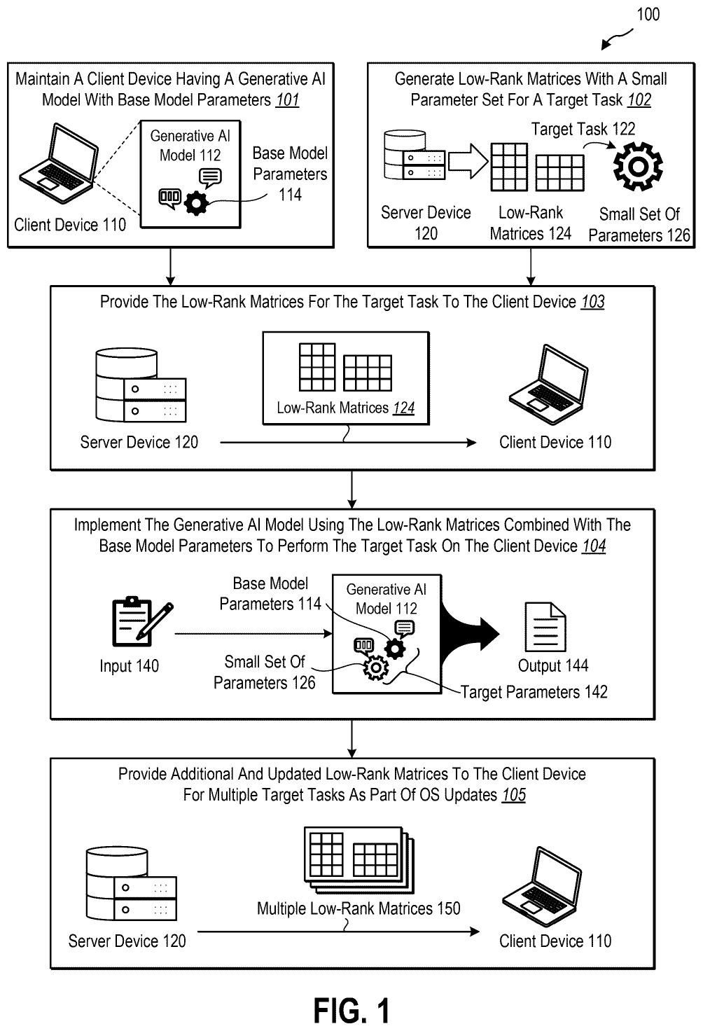

Implementation examples and details of the low-rank distribution system will be discussed in connection with the accompanying figures, which will be described next. For example, FIG. 1 illustrates an example overview of a low-rank distribution system that utilizes low-rank adaptation to distribute generative AI model updates and upgrades to a client device according to some implementations. While FIG. 1 provides a high-level overview of the invention, additional details are provided in subsequent figures.

FIG. 1 illustrates a series of acts 100 performed by or under the direction of the low-rank distribution system. As shown, the series of acts 100 briefly illustrates an example of the low-rank distribution system using a deployment framework to provide model updates to a client device that includes a generative AI model for implementing low-rank adaptations.

To elaborate, the series of acts 100 includes act 101 of maintaining a client device with a generative AI model and base model parameters. For instance, the client device 110 is an AI-based computing device with AI-specific hardware (e.g., a neural processing unit (NPU)) and a generative AI model 112 that is locally stored and implemented. In various implementations, the generative AI model 112 is a base model that includes a large set of base model parameters 114 (e.g., billions of parameters).

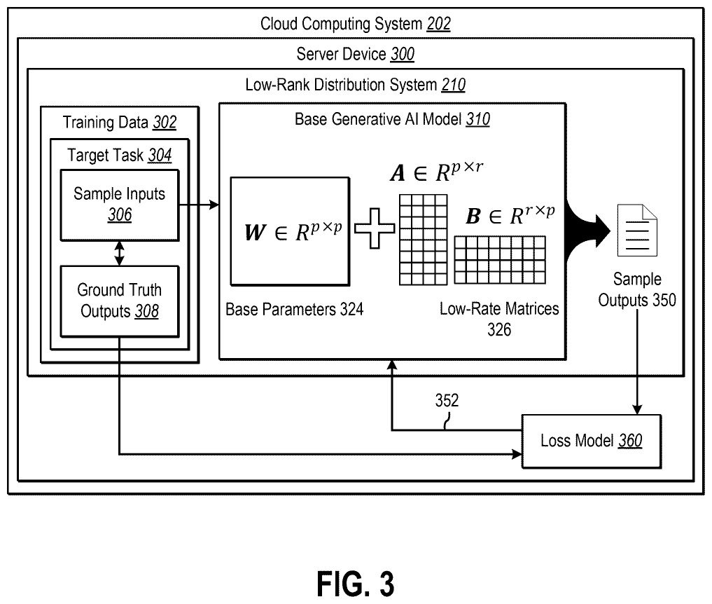

Act 102 includes generating low-rank matrices with a small parameter set for a target task. In various implementations, the low-rank distribution system uses a server device 120 with a copy of the generative AI model 112 to perform a target task 122. The target task 122 may correspond to the generative AI model performing a new feature or an updated version of an existing feature. As part of training the model, the low-rank distribution system generates low-rank matrices 124, which include a small set of parameters 126 that enable the generative AI model 112 to perform the target task 122. In some instances, the small set of parameters 126 is a few dozen megabytes (MB) in size. Additional details about generating low-rank matrices are provided below in connection with FIG. 3.

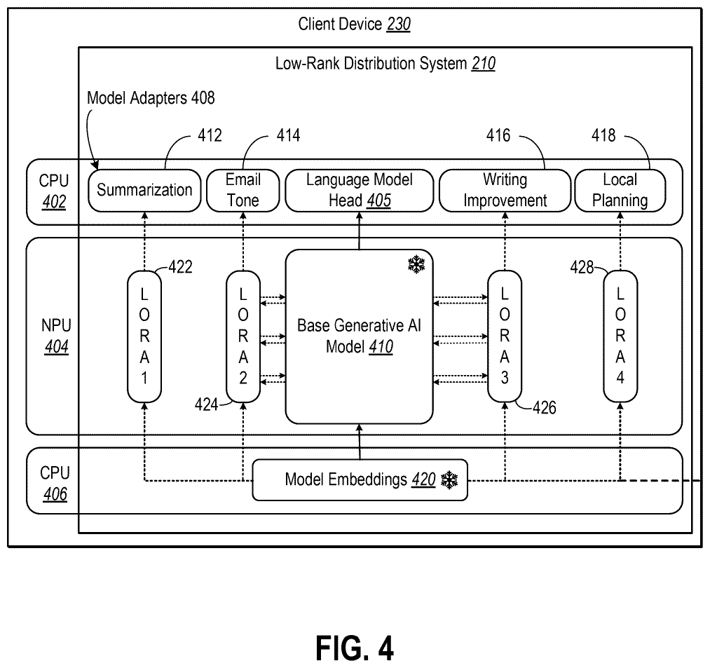

Act 103 includes providing the low-rank matrices for the target task to the client device. For example, the low-rank distribution system deploys the low-rank matrices 124 from the server device 120 to the client device 110 in a small package as part of a regularly scheduled operating system (OS) update. The client device 110 may receive and store the low-rank matrices 124 for the target task 122 within memory for future implementation. Furthermore, the low-rank distribution system may provide multiple sets of low-rank matrices to the client device 110 corresponding to the generative AI model performing multiple target tasks. Additional details about receiving and storing low-rank matrices on a client device are provided below in connection with FIG. 4.

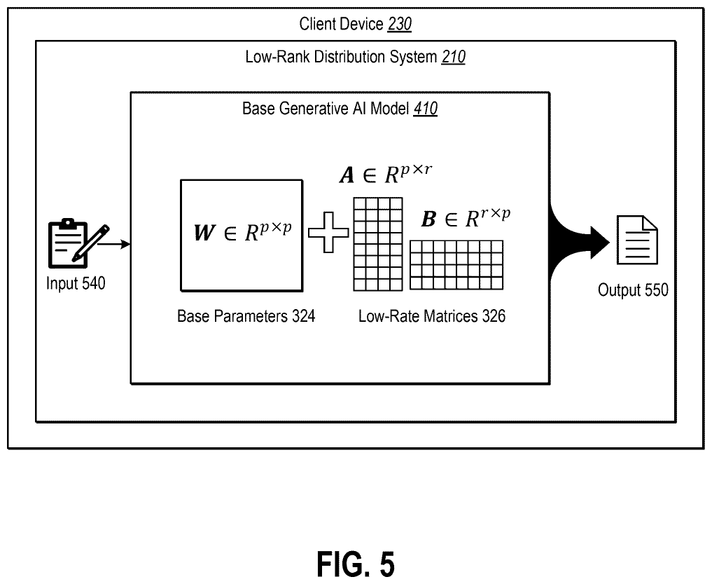

Act 104 includes implementing the generative AI model using the low-rank matrices combined with the base model parameters to perform the target task on the client device. For instance, in response to receiving a user request to locally perform the target task 122 at the client device 110, the low-rank distribution system identifies the low-rank matrices 124 corresponding to the target task 122. Combining the small set of parameters 126 of the low-rank matrices 124 with the large set of base model parameters 114, the low-rank distribution system generates a set of target parameters 142 that the generative AI model 112 implements to create an output 144 based on an input 140 for the target task 122. Additional details about implementing a generative AI model on the client device based on low-rank matrices are provided below in connection with FIG. 5.

Act 105 includes providing additional and updated low-rank matrices to the client device for multiple target tasks as part of OS updates. In various implementations, the low-rank distribution system continuously generates new and updated low-rank matrices corresponding to various target tasks. The low-rank distribution system may provide the multiple low-rank matrices 150 to the client device 110 to be selectively used by the generative AI model 112 to perform corresponding target tasks. As mentioned above, because of their small size, the low-rank distribution system can provide frequent updates and enhancements to the generative AI model on the client device, such as through regular OS updates rather than in massive, infrequent model replacement updates.

With a general overview in place, additional details are provided regarding the components, features, and elements of the low-rank distribution system. To illustrate, FIG. 2 shows an example computing environment where the low-rank distribution system is implemented according to some implementations. In particular, FIG. 2 illustrates an example of a computing environment 200 with various computing devices including a cloud computing system 202 and a client device 230, each associated with a low-rank distribution system 210. The cloud computing system 202 and the client device 230 are connected via a network 240. While FIG. 2 shows example arrangements and configurations of the low-rank distribution system 210 within the computing environment 200, other arrangements and configurations are possible.

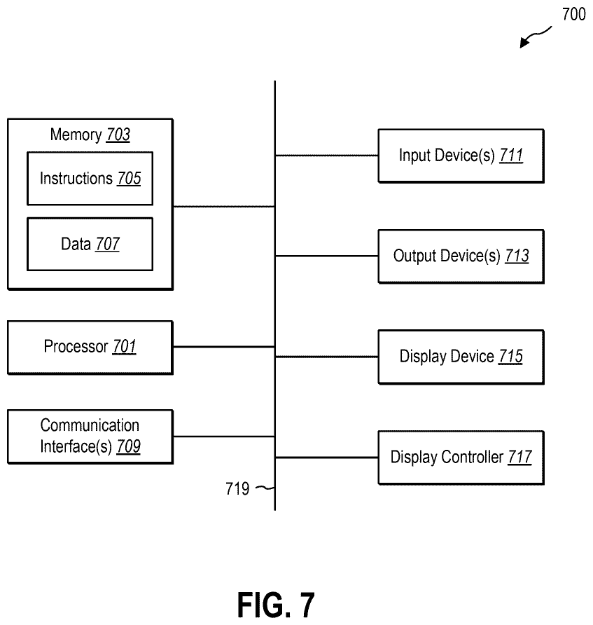

In various implementations, an illustrated component represents a single component. For example, the client device 230 is a single client device. In some implementations, one or more of the components shown are implemented on one or more computing devices, such as on one or more server devices. Further details regarding computing devices are provided below in connection with FIG. 7, which also includes additional details regarding networks, such as the network 240 shown.

As shown, the cloud computing system 202 includes a software distribution system 204 that facilitates providing software updates to various devices, including the client device 230. The software distribution system 204 may provide regular software updates, such as daily, weekly, bi-monthly, or monthly updates. The updates may correspond to OS updates, security updates, application updates, plugin updates, and/or other updates. The software distribution system 204 may also manage the development and rollout of updates.

As shown, the software distribution system 204 implements the low-rank distribution system 210. In various implementations, the low-rank distribution system 210 is located on a separate computing device from the software distribution system 204 within the cloud computing system 202 (or apart from the cloud computing system 202). In various implementations, the low-rank distribution system 210 operates independently of the software distribution system 204. Additionally, as shown, in some instances, some or all of the low-rank distribution system 210 is located on the client device 230.

In various implementations, including the illustrated implementation, the low-rank distribution system 210 includes various components and elements implemented in hardware and/or software. The low-rank distribution system 210 may include some components primarily implemented on the cloud computing system 202 and some components primarily implemented on the client device 230. For simplicity, components of the low-rank distribution system 210 are shown as being implemented on the cloud computing system 202. However, in some implementations, one or more of the components are implemented within the low-rank distribution system 210 located on the client device 230.

As shown, the low-rank distribution system 210 includes a low-rank matrices manager 212, a model distribution manager 214, an implementation manager 216, and a storage manager 220. The storage manager 220 includes a generative AI model 222 with a base parameter set 224, and low-rank matrices 226 with small parameter sets 228.

To elaborate, in various implementations, the low-rank matrices manager 212 facilitates the creation of low-rank matrices 226 with small parameter sets 228. For example, the low-rank matrices manager 212 trains a generative AI model 222 at the cloud computing system 202 on how the base parameter set 224 needs to be updated to perform a target task. In some implementations, the low-rank matrices manager 212 determines for which target tasks to generate low-rank matrices, including new or existing target tasks.

In various implementations, the model distribution manager 214 manages the distribution of low-rank matrices 226 to the client device 230. For example, on the cloud computing system 202, the model distribution manager 214 provides low-rank matrices 226 with small parameter sets 228 to the client device 230 in small software update packages. On the client device 230, the model distribution manager 214 may facilitate receiving and storing the small parameter sets 228.

In one or more implementations, the implementation manager 216 facilitates the selection and implementation of low-rank matrices corresponding to a target task for the generative AI model 222 on the client device 230. For instance, upon receiving a user request for the generative AI model 222 to perform a target task, the implementation manager 216 identifies and selects the relevant set of low-rank matrices, and combines them with the corresponding set of small parameter sets, along with the base parameter set 224 that the generative AI model 222 uses to perform the target task.

As shown, the computing environment 200 includes the client device 230 with a client application 232. In some implementations, the client device 230 is associated with a user (e.g., a user client device). In various instances, the client application 232 is a web browser, mobile application, or another type of computer program that provides data and/or services to users. In some instances, the client application 232 represents the OS of the client device 230, which includes a user interface for allowing a user to submit requests and prompts to be performed locally by the generative AI model 222 on the client device 230 (e.g., without exchanging communications with remote sources).

As mentioned above, in various implementations, the client device 230 is an AI-based device that includes special hardware (e.g., one or more NPUs for processing trillions of operations per second) and/or other hardware elements for processing machine learning model operations. Accordingly, the client device 230 may include one or more generative AI models for performing generative tasks.

Turning to the next set of figures, these figures illustrate examples of distributing and implementing low-rank adaptation on a client device with a generative AI model. For instance, FIG. 3 provides additional details regarding generating low-rank matrices. In particular, FIG. 3 illustrates an example sequence diagram of generating low-rank matrices at a cloud computing system to be provided to a client device for a target task according to some implementations.

As shown, FIG. 3 includes a server device 300 implemented on the cloud computing system 202. The server device 300 includes an instance of the low-rank distribution system 210. The low-rank distribution system 210 generates low-rank matrices 326 for a target task through training. To illustrate, the low-rank distribution system 210 uses a base generative AI model 310 with base parameters 324 and the low-rank matrices 326. The low-rank distribution system 210 also obtains training data 302 that includes sample inputs 306 and ground truth outputs 308 corresponding to a target task 304.

In various implementations, the base generative AI model 310 is a Phi Silica language model that leverages NPUs for efficient client device-based handling of AI tasks. As shown, the base generative AI model 310 includes the base parameters 324. In some implementations, the base generative AI model 310 includes over 3 billion parameters (e.g., a mini-language model with 3.3-3.8 billion parameters). The base parameters 324 may require around 3 GB in size to store. In one or more implementations, the base parameters 324 correspond to the same base parameters located in base generative AI models on client devices. For example, the base generative AI model 310 is a copy of the generative AI model installed or deployed to client devices with a generative AI model.

The base generative AI model 310 in FIG. 3 also includes the low-rank matrices 326, which are used for training the base generative AI model 310 to perform a target task. The low-rank matrices 326 may start with initial, default, and/or random values. As shown, the low-rank matrices 326 include a first matrix (e.g., A) and a second matrix (e.g., B). The low-rank matrices 326 each have one dimension (e.g., p) that matches the dimension of the matrix associated with the base parameters 324 (e.g., W). By doing so, the low-rank matrices 326 can be combined with the base parameters 324.

In one or more implementations, the low-rank distribution system 210 may vary the other dimensions (e.g., r) of the low-rank matrices 326 and determine the optimal number through testing. For example, the low-rank distribution system 210 determines that an r of 16 is more efficient and equally accurate as an r of 32. The greater the r, the greater the size of the low-rank matrices 326. For instance, an r of 32 results in the low-rank matrices 326 being 40 MB, while an r of 16 results in the low-rank matrices 326 being 20 MB in size. In any case, the size needed to store the low-rank matrices 326 is significantly smaller (e.g., around 100 times smaller) than the size of the base parameters 324.

As mentioned above, the training data 302 includes sample inputs 306 and ground truth outputs 308 corresponding to a target task 304. For example, different target tasks may require different training data to be used to train the base generative AI model 310 to perform the respective target task. Accordingly, the sample inputs 306 and the ground truth outputs 308 for the sample inputs 306 both correspond to the target task 304.

In various implementations, the low-rank distribution system 210 (or another system) trains the base generative AI model 310 to perform the target task 304. For example, the low-rank distribution system 210 utilizes supervisory learning and backpropagation to train the base generative AI model 310. In particular, the low-rank distribution system 210 provides the sample inputs 306 to the base generative AI model 310 to generate sample outputs 350. The low-rank distribution system 210 then uses a loss model 360 to compare the sample outputs 350 to the ground truth outputs 308 to determine an error amount, which is provided to the base generative AI model 310 as feedback 352.

Based on the feedback 352, the base generative AI model 310 iteratively updates its parameters until the model converges and/or reaches another stopping point. Notably, when updating and fine-tuning its parameters, the low-rank distribution system 210 does not change or modify the base parameters 324 but rather only tunes the low-rank matrices 326. Indeed, the base parameters 324 remain static throughout the training and fine-tuning process, allowing the low-rank matrices 326 to be updated to specifically correspond to the target task 304.

The low-rank distribution system 210 may repeat the training process for other target tasks. In each case, the low-rank distribution system 210 only updates the corresponding small set of parameters of the low-rank matrices to become particular to performing the corresponding target task (when combined with the base parameters 324). Additionally, because the low-rank matrices 326 (e.g., low-rank adaptation) for each target task require little space, a client device can store numerous versions.

In various implementations, the low-rank matrices 326 represent data delta compression for the model corresponding to a target task. For example, if the low-rank distribution system 210 created a first set of parameters by training the base generative AI model 310, as well as created a second set of parameters by training a separate specialized generative AI model for performing the target task, the low-rank matrices would represent the difference between the two parameter sets. Because only the differences are captured, the resulting low-rank matrices are small in size (e.g., a few dozen MBs).

As mentioned above, FIG. 4 provides additional details about receiving and storing low-rank matrices on a client device. In particular, FIG. 4 illustrates an example layout of a client device having a generative AI model that includes low-rank adapters for various target tasks according to some implementations. FIG. 4 includes the client device 230 with the low-rank distribution system 210 introduced above.

As shown, the client device 230 includes a first CPU 402, an NPU 404, and a second CPU 406. In some implementations, the first CPU 402 and the second CPU 406 are the same. In some implementations, the first CPU 402 and the second CPU 406 are different CPUs. While the client device 230 in FIG. 4 shows a particular configuration of components and elements, other configurations, components, and/or elements are possible.

In various implementations, the low-rank distribution system 210 utilizes model adapters (low-rank matrices for low-rank adaptation) to perform target tasks using a generative AI model on a client device. To illustrate, the client device 230 includes a base generative AI model 410, which has a language model head for processing AI-based tasks. In some implementations, the base generative AI model 410 is a phi-silica language model.

As shown, the base generative AI model 410 also includes a model head 405 for providing basic interface communications with a user or the OS of the client device 230. For example, the model head 405 allows users to make requests to be fulfilled by the base generative AI model 410. Additionally, the base generative AI model 410 utilizes model embeddings 420 to perform AI tasks. As shown, the client device 230 utilizes the CPU and NPU to process AI tasks using the base generative AI model 410.

In addition, the client device 230 includes model adapters 408. In various implementations, each of the model adapters 408 corresponds to a target task and is stored as low-rank matrices. The model adapters 408 provide low-rank adaptation to the base generative AI model 410 to perform a specific target task. As shown, the model adapters 408 include a summarization adapter 412, an email tone adapter 414, a writing improvement adapter 416, and a local planning adapter 418. In various implementations, the client device 230 includes any number of model adapters. As mentioned, each model adapter is insignificant in size compared to the size of the large set of base model embeddings.

As shown, each of the model adapters 408 includes low-rank matrices (e.g., low-rank adaptation or “LoRA”) with small parameter sets used to perform the corresponding target tasks. For example, the summarization adapter 412 includes a first small set of parameters 422, the email tone adapter 414 includes a second small set of parameters 424, the writing improvement adapter 416 includes a third small set of parameters 426, and the local planning adapter 418 includes a fourth small set of parameters 428.

As mentioned, an instance of the low-rank distribution system 210 on a server device or at a cloud computing system may provide one or more of the model adapters 408 to the client device 230 as part of a regular software update. By doing so, the low-rank distribution system 210 can continuously develop, train, and deploy updated model adapters to client devices to ensure highly efficient and accurate processing of AI tasks on the client devices.

In various implementations, a deployed model adapter may be an updated version of a previously deployed model adapter or a new model adapter that provides a new feature to the base generative AI model 410. In some implementations, the low-rank distribution system 210 provides a model adapter in a separate deployment.

When a request is received from a user or system, the low-rank distribution system 210 may identify a target task and determine the corresponding model adapter to select. For example, the low-rank distribution system 210 selects a particular model adapter from a library or cache of low-rank model adapters. As noted above, the low-rank distribution system 210 only needs to select one of the model adapters 408 to provide to the base generative AI model 410 to perform the target task. Indeed, as each of the model adapters 408 is trained with only the large set of base model parameters, adding more than one model adapter would likely result in processing errors.

Maintaining a collection or library of model adapters 408 allows the client device 230 to use the base generative AI model 410 to perform a variety of different target tasks. Indeed, it would be infeasible to store a separate generative AI model for each target task or group of target tasks. Similarly, even a more generalized generative AI model would require billions of additional parameters and gigabytes of additional storage space. In contrast, by using model adapters 408, the low-rank distribution system 210 can provide dozens or even hundreds of target task capabilities with only needing to store a small parameter set for each adapter.

An example of the client device 230 implementing a model adapter is provided in the next figure. As mentioned above, FIG. 5 provides additional details about implementing a generative AI model on the client device based on low-rank matrices. In particular, FIG. 5 illustrates an example diagram of implementing the generative AI model on the client device to perform a target task using low-rank matrices and low-rank adaptation according to some implementations.

As shown, FIG. 5 includes the client device 230 introduced above. In some implementations, the client device 230 in FIG. 5 matches the client device from FIG. 4. The client device 230 includes the low-rank distribution system 210 and a base generative AI model 410. The base generative AI model 410 includes the base parameters 324 and the low-rank matrices 326. In particular, the low-rank matrices 326 may correspond to a particular model adapter for a specific target task, where the low-rank matrices 326 were selected from memory on the client device 230.

In various implementations, the low-rank distribution system 210 uses the base parameters 324 and the low-rank matrices 326 (e.g., the small set of parameters) of the selected model adapter to generate a set of target parameters. For example, the low-rank distribution system 210 multiplies, adds, merges, or otherwise combines the large set of base parameters for the base generative AI model 410 with the small set of parameters from the low-rank matrices 326 to generate a set of target parameters (e.g., Target Matrix T=W×A B).

With the set of target parameters (or just combining W×A B at implementation time), the base generative AI model 410 temporarily transforms into an updated, specialized generative AI model specifically trained to perform the target task. To illustrate, the updated generative AI model performs the target task by generating an output 550 (e.g., a target task output) from the input 540. Depending on which model adapter and corresponding low-rank matrices the low-rank distribution system 210 combines with the large parameter set of the base model, the low-rank distribution system 210 can leverage the model into a variety of specialized models.

As noted, due to the small size of low-rank matrices, the low-rank distribution system 210 can provide numerous updates to the client device 230 for storage and selective implementation at any time. Additionally, because model adapters can be bundled in small packages, the client device 230 requires low amounts of bandwidth and storage. Furthermore, the computational resources needed by the client device 230 to apply these smaller updates are considerably less, and regular updates ensure optimally performing models.

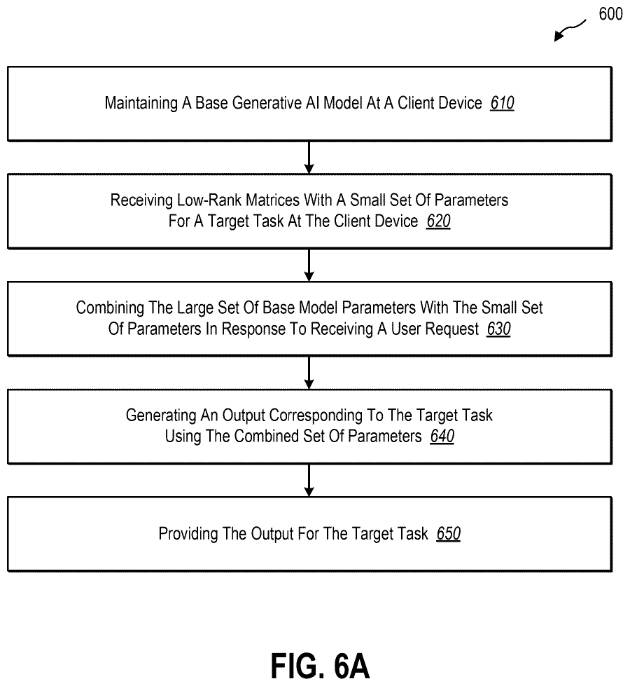

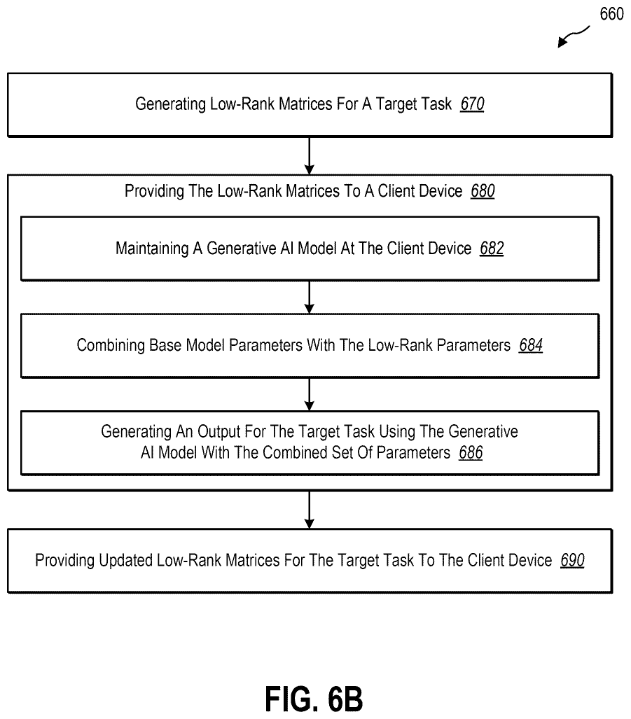

Turning now to the next set of figures, FIGS. 6A-6B each illustrate an example series of acts of a computer-implemented method for deploying generative AI model updates to one or more client devices according to some implementations. While FIGS. 6A-6B each illustrate acts according to one or more implementations, alternative implementations may omit, add to, reorder, and/or modify any of the acts shown.

The acts in FIGS. 6A-6B can each be performed as part of a method (e.g., a computer-implemented method). Alternatively, a computer-readable medium can include instructions that, when executed by a processing system with a processor, cause a computing device to perform the acts in FIGS. 6A-6B. In some implementations, a system (e.g., a processing system comprising a processor) can perform the acts in FIGS. 6A-6B. For example, the system includes a processing system and a computer memory including instructions that, when executed by the processing system, cause the system to perform various actions or steps.

As shown in FIG. 6A, the series of acts 600 includes act 610 of maintaining a base generative AI model at a client device. For instance, in example implementations, act 610 involves maintaining, at a client device, a generative AI model with a large set of base model parameters. In various implementations, in connection with act 610, the client device includes a neural processing unit (NPU) for implementing the generative AI model. In some instances, the generative AI model is a phi silica language model that utilizes the neural processing unit to generate the output based on the set of target parameters. In one or more implementations, the generative AI model maintained on the client device is multiple gigabytes in storage size.

As further shown, the series of acts 600 includes act 620 of receiving low-rank matrices with a small set of parameters for a target task at the client device. For instance, in example implementations, act 620 involves receiving, at the client device, low-rank matrices corresponding to a target task, where the low-rank matrices include a small set of parameters corresponding to the target task.

In various implementations, act 620 includes receiving the low-rank matrices from a software distribution system as part of a regular operating system update for the client device. In some instances, act 620 includes receiving multiple updates that include low-rank matrices from a software distribution system more frequently than receiving an update to the large set of base model parameters. In some instances, act 620 includes modifying an existing version of low-rank matrices corresponding to the target task stored on the client device in response to receiving the low-rank matrices corresponding or relating to the target task.

In some implementations, act 620 includes adding the low-rank matrices corresponding to the target task to a library of low-rank matrices corresponding to target tasks stored on the client device, where the low-rank matrices correspond to a target task not previously included in the target tasks. In various implementations, act 620 includes receiving multiple sets of low-rank matrices corresponding to multiple tasks, where each of the multiple sets of low-rank matrices includes small sets of parameters that are combined separately with the large set of base model parameters. When implemented by the generative AI model, these combined sets of parameters enable or cause the generative AI model to perform a corresponding task from the multiple tasks.

In some implementations, the low-rank matrices are over 100 times smaller in size than the large set of base model parameters. In some instances, the low-rank matrices are less than 50 megabytes in storage size. In various implementations, act 620 includes receiving the low-rank matrices as part of an operating system update for the client device.

As further shown, the series of acts 600 includes act 630 of combining the large set of base model parameters with the small set of parameters in response to receiving a user request. For instance, in example implementations, act 630 involves combining the large set of base model parameters with the small set of parameters corresponding to the target task to generate a set of target parameters in response to receiving a user request at the client device to perform the target task.

In some implementations, in connection with act 630, the client device generates the output using the generative AI model without exchanging communications with remote sources. In some instances, generating the set of target parameters includes modifying the large set of base model parameters based on the small set of parameters, where the set of target parameters and the large set of base model parameters have the same or matching dimensions.

As shown further, the series of acts 600 includes act 640 of generating an output corresponding to the target task using the combined set of parameters. For instance, in example implementations, act 640 involves generating an output corresponding to the target task at the client device by implementing the generative AI model using the set of target parameters.

As further shown, the series of acts 600 includes act 650 of providing the output for the target task. In some instances, in example implementations, act 650 involves providing the output for the target task in response to the user request. In some implementations, the series of acts 600 includes providing a set of sample inputs corresponding to the target task to a copy of the generative AI model that includes the large set of base model parameters and an initialized small set of parameters to generate sample outputs and iteratively updating the initialized small set of parameters without updating the large set of base model parameters to generate the low-rank matrices for the target task based on comparing corresponding sample outputs to ground truth outputs.

As shown in FIG. 6B, the series of acts 660 includes act 670 of generating low-rank matrices for a target task. For instance, in example implementations, act 670 involves generating low-rank matrices corresponding to a target task within a generative AI model at a server device. In some implementations, act 670 includes generating multiple sets of low-rank matrices corresponding to multiple tasks at a server device. In various implementations, act 670 includes generating the updated low-rank matrices corresponding to the target task at a server device.

As further shown, the series of acts 660 includes act 680 of providing the low-rank matrices to a client device. For instance, in example implementations, act 680 involves providing the low-rank matrices corresponding to the target task, which includes a small set of parameters, to the client device. In some implementations, act 680 includes providing the multiple sets of low-rank matrices to the client device for future implementation. In various implementations, act 680 includes providing the updated low-rank matrices corresponding to the target task as part of a regular operating system update for the client device.

In some implementations, act 680 includes multiple sub-acts. As shown, act 680 includes sub-act 682 of maintaining a generative AI model at the client device. For instance, sub-act 682 includes maintaining the generative AI model with a large set of base model parameters. As further shown, act 680 includes sub-act 684 of combining base model parameters with the low-rank parameters. For instance, sub-act 684 includes combining the large set of base model parameters with the small set of parameters corresponding to the target task to generate a set of target parameters. As further shown, act 680 includes sub-act 686 of generating an output for the target task using the generative AI model with the combined set of parameters. For instance, sub-act 686 includes generating an output corresponding to the target task by implementing the generative AI model using the set of target parameters.

As further shown, the series of acts 660 includes act 690 of providing updated low-rank matrices for the target task to the client device. For instance, in example implementations, act 690 involves providing the updated low-rank matrices corresponding to the target task to the client device, where the client device replaces a stored version of the low-rank matrices with the updated low-rank matrices.

FIG. 7 illustrates certain components that may be included within a computer system 700. The computer system 700 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 700 represents one or more of the client devices, server devices, or other computing devices described above. For example, the computer system 700 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 700 includes a processing system including a processor 701. The processor 701 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 701 may be referred to as a central processing unit (CPU) and may cause computer-implemented instructions to be performed. Although the processor 701 shown is just a single processor in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 705 and the data 707 may be stored in the memory 703. The instructions 705 may be executable by the processor 701 to implement some or all of the functionality disclosed herein. Executing the instructions 705 may involve the use of the data 707 stored in the memory 703. Any of the various examples of modules and components described herein may be implemented, partially or wholly, as instructions 705 stored in memory 703 and executed by the processor 701. Any of the various examples of data described herein may be among the data 707 stored in memory 703 and used during the execution of the instructions 705 by the processor 701.

A computer system 700 may also include one or more communication interface(s) 709 for communicating with other electronic devices. The one or more communication interface(s) 709 may be based on wired communication technology, wireless communication technology, or both. Some examples of the one or more communication interface(s) 709 include a Universal Serial Bus (USB), an Ethernet adapter, a wireless adapter that operates according to an Institute of Electrical and Electronics Engineers (IEEE) 702.11 wireless communication protocol, a Bluetooth® wireless communication adapter, and an infrared (IR) communication port.

A computer system 700 may also include one or more input device(s) 711 and one or more output device(s) 713. Some examples of the one or more input device(s) 711 include a keyboard, mouse, microphone, remote control device, button, joystick, trackball, touchpad, and light pen. Some examples of the one or more output device(s) 713 include a speaker and a printer. A specific type of output device typically included in a computer system 700 is a display device 715. The display device 715 used with implementations disclosed herein may utilize any suitable image projection technology, such as liquid crystal display (LCD), light-emitting diode (LED), gas plasma, electroluminescence, or the like. A display controller 717 may also be provided for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, and a data bus. For clarity, the various buses are illustrated in FIG. 7 as a bus system 719.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Instead, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The term “determining” encompasses a wide variety of actions and, therefore, can include calculating, computing, processing, deriving, investigating, looking up (e.g., looking up in a table, a data repository, or another data structure), ascertaining, and the like. Additionally, “determining” can include receiving (e.g., receiving information), accessing (e.g., accessing data in a memory), and the like. Furthermore, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to exclude the existence of additional implementations that also incorporate the recited features. For example, any element or feature described concerning an implementation herein may be combinable with any element or feature of any other implementation described herein if compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that fall within the meaning and range of equivalency of the claims are to be embraced within their scope.

What is claimed is:

1. A computer-implemented method for deploying generative artificial intelligence (AI) model updates to one or more client devices, comprising:
maintaining, at a client device, a generative AI model with a large set of base model parameters;
receiving, at the client device, low-rank matrices corresponding to a target task, the low-rank matrices including a small set of parameters corresponding to the target task;
in response to receiving a user request at the client device to perform the target task, combining the large set of base model parameters with the small set of parameters corresponding to the target task to generate a set of target parameters;
generating, at the client device, an output corresponding to the target task by implementing the generative AI model using the set of target parameters; and
providing the output for the target task in response to the user request.

2. The computer-implemented method of claim 1, further comprising receiving the low-rank matrices from a software distribution system as part of a regular operating system update for the client device.

3. The computer-implemented method of claim 1, further comprising receiving multiple updates that include low-rank matrices from a software distribution system more frequently than receiving an update to the large set of base model parameters.

4. The computer-implemented method of claim 1, further comprising modifying an existing version of low-rank matrices corresponding to the target task stored on the client device in response to receiving the low-rank matrices corresponding to the target task.

5. The computer-implemented method of claim 1, further comprising adding the low-rank matrices corresponding to the target task to a library of low-rank matrices corresponding to target tasks stored on the client device, wherein the low-rank matrices correspond to a target task not previously included in the target tasks.

6. The computer-implemented method of claim 1, further comprising receiving multiple sets of low-rank matrices corresponding to multiple tasks, wherein each of the multiple sets of low-rank matrices includes small sets of parameters that are combined separately with the large set of base model parameters and that, when implemented by the generative AI model, cause the generative AI model to perform a corresponding task from the multiple tasks.

7. The computer-implemented method of claim 1, wherein the client device includes a neural processing unit (NPU) for implementing the generative AI model.

8. The computer-implemented method of claim 7, wherein the generative AI model is a phi silica language model that utilizes the neural processing unit to generate the output based on the set of target parameters.

9. The computer-implemented method of claim 1, wherein:
the generative AI model maintained on the client device is multiple gigabytes; and
the low-rank matrices are less than 50 megabytes.

10. The computer-implemented method of claim 1, wherein the client device generates the output using the generative AI model without exchanging communications with remote sources.

11. The computer-implemented method of claim 1, wherein generating the set of target parameters includes modifying the large set of base model parameters based on the small set of parameters, wherein the set of target parameters and the large set of base model parameters have matching dimensions.

12. The computer-implemented method of claim 1, wherein the low-rank matrices are generated by:
providing a set of sample inputs corresponding to the target task to a copy of the generative AI model that includes the large set of base model parameters and an initialized small set of parameters to generate sample outputs; and
based on comparing corresponding sample outputs to ground truth outputs, iteratively updating the initialized small set of parameters without updating the large set of base model parameters to generate the low-rank matrices for the target task.

13. A system comprising:
a processing system having a processor; and
a computer memory including instructions that, when executed by the processing system, cause the system to carry out operations comprising:
maintaining, at a client device, a generative AI model with a large set of base model parameters;
receiving, at the client device, low-rank matrices corresponding to a target task, the low-rank matrices including a small set of parameters corresponding to the target task;
in response to receiving a user request at the client device to perform the target task, combining the large set of base model parameters with the small set of parameters corresponding to the target task to generate a set of target parameters;
generating, at the client device, an output corresponding to the target task by implementing the generative AI model using the set of target parameters; and
providing the output for the target task in response to the user request.

14. The system of claim 13, wherein the low-rank matrices are over 100 times smaller in size than the large set of base model parameters.

15. The system of claim 13, further comprising receiving the low-rank matrices as part of an operating system update for the client device.

16. The system of claim 13, wherein:
the client device includes a neural processing unit (NPU) for implementing the generative AI model; and
the generative AI model is a phi silica language model that utilizes the neural processing unit to generate the output based on the set of target parameters.

17. A computer-implemented method for deploying generative artificial intelligence (AI) model updates to one or more client devices, comprising:
generating, at a server device, low-rank matrices corresponding to a target task within a generative AI model;
providing, to a client device, the low-rank matrices corresponding to the target task, the low-rank matrices including a small set of parameters corresponding to the target task, wherein the client device:
maintains the generative AI model with a large set of base model parameters;
combines the large set of base model parameters with the small set of parameters corresponding to the target task to generate a set of target parameters; and
generates an output corresponding to the target task by implementing the generative AI model using the set of target parameters; and
providing, to the client device, updated low-rank matrices corresponding to the target task, wherein the client device replaces a stored version of the low-rank matrices with the updated low-rank matrices.

18. The computer-implemented method of claim 17, wherein the low-rank matrices are generated by:
providing a set of sample inputs corresponding to the target task to a copy of the generative AI model that includes the large set of base model parameters and an initialized small set of parameters to generate sample outputs; and
based on comparing corresponding sample outputs to ground truth outputs, iteratively updating the initialized small set of parameters without updating the large set of base model parameters to generate the low-rank matrices for the target task.

19. The computer-implemented method of claim 17, further comprising:
generating, at the server device, multiple sets of low-rank matrices corresponding to multiple tasks; and
providing the multiple sets of low-rank matrices to the client device for future implementation.

20. The computer-implemented method of claim 17, further comprising:
generating, at the server device, the updated low-rank matrices corresponding to the target task; and
providing the updated low-rank matrices corresponding to the target task as part of a regular operating system update for the client device.
